(19) United States
(12) Patent Application Publication
(10) Pub. No.: US 2007/0083450 A1
(43) Pub. Date: Apr. 12, 2007

(54) Commercial transaction management system

(75) Inventor: Rikiya Ishiguro, Tokyo (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: HONDA MOTOR CO., LTD.

(21) Appl. No.: 10/576,191

(22) PCT Filed: Mar. 15, 2005
(86) PCT No.: PCT/JP05/04540

§ 371 Date: Apr. 17, 2006

(30) Foreign Application Priority Data
Mar. 17, 2004 (JP) 2004-077069

(51) Int. Cl. G06Q 40/00

(52) U.S. Cl. 705/36 R; 705/37

(57) ABSTRACT

There is provided a system for appropriately determining a second trader as a partner of commercial transaction with a plurality of first traders, among a plurality of second traders according to a given rule. According to the commercial transaction management system of the present invention, a fourth processing unit 114 determines a “selection index”, based on a first index according to “cost” needed for the commercial transaction for each of the first trader and each of the second trader, a second index according to time needed for the commercial transaction, and a third index according to quality of goods and the like of the second trader. Also, the fourth processing unit 114 selects the second trader as the partner of commercial transaction with the first trader, based on the selection index. Further, a fifth processing unit 115 determines a “received order content” of the second trader, based on a “placed order content” of the first trader recognized by a first processing unit 111. A communication processing unit 130 transmits the “received order content” to a second terminal device 220 of the second trader selected by the fourth processing unit.

### TECHNICAL FIELD

The present invention relates to a system for managing commercial transaction with a trader being the party involved, based on a network communication with a terminal device of the trader.

### BACKGROUND ART

With the recent development of traffic network and transportation facilities, worldwide import and export of goods are carried out widely among numerous traders based in Japan, the United States, China, European countries and the like.

Heretofore, a system for managing import and export using network communication has been proposed (refer to, for example, patent document, scope of claim in gazette of Japanese Patent laid-open 2001-338032). In this system, a request information of a first trader, such as a goods owner entrusting operation such as cargo transport, is provided to a second trader accepting the operation via a network. Also, a quotation and application information of the second trader is provided to the first trader via the network. By doing so, the first trader can determine which second trader to entrust operation, based on the quotation and application information.

### DISCLOSURE OF INVENTION

However, when worldwide import and export is performed widely as mentioned above, there are cases where management of the entrusting and accepting of operation, such as import and export, is extremely difficult, because of negotiation and contract between each of the traders and the like. That is, there is a possibility of an occurrence of conflict within numerous entrusting of operation by numerous first traders, such as placing of a huge number of import orders. On the other hand, there is a possibility of an occurrence of conflict within numerous offerings for accepting operation by numerous second traders, such as escalation of competition in receiving the order. In such cases, there is no standard rule for sorting out the numerous operations entrusted by numerous first traders, and for making the numerous second traders accept the same. Therefore, there is a fear of occurrence of conflict or friction between the traders, which might obstruct the execution of operations such as import and export.

Therefore, the problem to be solved by the invention is to provide a system for appropriately determining a second trader as a partner of commercial transaction with a plurality of first traders, among a plurality of second traders according to a given rule.

The present invention relates to a system for managing commercial transaction between a plurality of first traders and a plurality of second traders as parties involved, based on network communication with a first terminal device of the first trader placing order of goods, and a second terminal device of the second trader receiving order of goods.

The system for managing commercial transaction for solving the above problem according to the present invention comprises a first processing unit for determining a first index according to cost needed for commercial transaction with the first trader for each of the second trader, based on a part of or all of a placed order content of the first trader, upon recognizing the placed order content including category, quantity, desired delivery date, and priority rank of the ordered goods by the first trader based on the communication with the first terminal device, a second processing unit for determining a second index according to time needed for commercial transaction with the first trader for each of the second trader, based on a part of or all of the placed order content of the first trader, upon recognizing the placed order content of the first trader based on the communication with the first terminal device, a third processing unit for determining a third index according to quality or level, upon recognizing the quality of goods or the level of service of each of the second trader, a fourth unit for determining a selection index for selecting the second trader, based on the first index, the second index, and the third index determined by the first processing unit, the second processing unit, and the third processing unit, respectively, and for determining the second trader receiving order of goods from the first trader, based on the selection index, a fifth unit for determining a received order content including the category, quantity, delivery date, and priority rank of the ordered goods received by the second trader, based on the placed order content by the first trader recognized by the first or the second processing unit, and a communication processing unit for transmitting the received order content determined by the fifth processing unit, to the second terminal device of the second trader selected by the fourth processing unit.

The commercial transaction management system of the present invention performs processes described hereafter.

First, the first processing unit recognizes the “placed order content” of each first trader, based on the communication with the first terminal device. The “placed order content” includes “category”, “quantity”, “desired delivery date”, and “priority rank” of the goods ordered by the first trader. Then, the first processing unit determines the “first index” depending on “cost” needed for the commercial transaction for each of the second trader, based on a part of or all of the “placed order content” of each first trader.

The term that a component x of the present invention recognizes y includes the following: x receives y, x retrieves y from a data base or a memory device, x determines (calculates, estimates, measures, and the like) y based on received data or the retrieved data, and the like.

Next, the second processing unit recognizes the “placed order content” of each first trader, based on the communication with the first terminal device, and then recognizes the “second index” depending on “time” needed for the commercial transaction for each of the second trader, based on a part of or all of the “placed order content”.

Next, the third processing unit recognizes the quality of the goods or the level of the service for each second trader, and then determines the “third index” of each of the second trader depending on the “quality” or the “level”.

Further, the fourth processing unit determines the “selection index” for selecting the second trader, based on the first, the second, and the third index, and then selects the second trader for receiving order of goods from the first trader, based on the selection index.

Further, the fifth processing unit determines the “received order content” including the category, quantity, delivery date, and priority rank of the ordered goods received by the second trader, based on the “placed order content” by the first trader recognized by the first or the second processing unit.

Still further, the communication processing unit transmits the “received order content” determined by the fifth processing unit, to the second terminal device of the second trader selected by the fourth processing unit.

As a result, the second trader can produce ordered goods according to the category, quantity, and priority rank of the ordered goods included in the “placed order content” transmitted to the second terminal device, and can transport the goods according to the order to the first trader at an appropriate timing.

As is explained above, the second trader for producing the goods ordered by a plurality of first traders is selected based on the “selection index”. Also, the cost needed for the commercial transaction, and the time needed for the commercial transaction for each of the first trader and the second trader, and the quality of the goods or the level of the service of the second trader are reflected in the “selection index”. Therefore, according to the commercial transaction managing system of the present invention, it is possible to select the second trader which is appropriate as the partner in commercial transaction with the first trader, from a view point of cost, time, quality of the goods, and the like.

As a result, in a case where numerous orders of goods are placed by numerous first traders, and numerous second traders receive the orders, it is possible to carry out a smooth commercial transaction by resolving conflict or friction between the traders. Here, one trader may place order of goods as the “first trader” and at the same time may receive order of goods as the partner of commercial transaction as the “second trader” with another first trader.

Also, the commercial transaction management system of the present invention is characterized in that the fourth processing unit determines the selection index based on the first index, the second index, and the third index, upon recognizing an order placing policy of the first trader indicating the importance to the first trader of the cost needed for the commercial transaction, the time needed for the commercial transaction, and the quality of the goods or the level of the service, and upon weighing the first, the second, and the third index in accordance with the order placing policy of the first trader.

According to the commercial transaction management system of the present invention, the “selection index” is determined according to the “order placing policy”, which indicates the importance for the first trader of cost needed for the commercial transaction, the time needed for the commercial transaction, and the quality of the goods and the like. For example, if the first trader values the quality of the goods and the like more than the commercial transaction cost and the commercial transaction time, then the third index depending on the quality of the goods and the like is reflected more strongly in the selection index than the first index depending on the commercial transaction cost and the second index depending on the commercial transaction time. Therefore, the appropriate second trader, in consideration of the order placing policy of the first trader, can be selected as the partner of commercial transaction with the first trader.

Moreover, the commercial transaction management system of the present invention is characterized in that the fourth processing unit determines the selection index based on an order receiving policy of the second trader indicating the magnitude of the desire by the second trader to have commercial transaction with each of the first trader, upon recognizing the order receiving policy of the second trader based on the communication with the second terminal device.

According to the commercial transaction management system of the present invention, the “selection index” is determined according to the “order receiving policy”, which indicates the magnitude of the desire by the second trader to commence commercial transaction with each of the first trader. For example, if the desire of the second trader to commence commercial transaction with the first trader B is stronger than that with the first trader A, then the “selection index” of the second trader for the first trader B is determined to be greater than the “selection index” of the second trader for the first trader A. Therefore, the appropriate second trader, in consideration of the order receiving policy, can be selected as the partner of commercial transaction with the first trader.

Still further, the commercial transaction management system is characterized by further comprising a sixth processing unit for recognizing a production plan of goods prepared by the second terminal device, based on the communication with the second terminal device to which the placed order content is transmitted by the communication processing unit, and for recognizing the delivery date to the first trader of the goods produced by the second trader in accordance with the production plan, wherein the communication processing unit transmits the delivery date recognized by the sixth processing unit to the first terminal device.

According to the commercial transaction management system of the present invention, the sixth processing unit recognizes the “delivery date” of the ordered goods produced by the second trader to the first trader, based on the communication with the second terminal device. Also, the communication processing unit transmits the “delivery date” recognized by the sixth processing unit to the first terminal device of the relevant first trader.

As a result, the first trader can prepare for the operation after receiving the ordered goods produced by the second trader, such as transporting the goods to the customers or the dealers, based on the delivery date transmitted to the first terminal device.

Moreover, the commercial transaction management system of the present invention is characterized by further comprising a first correction processing unit for correcting the first index based on an order receiving status or a production progress status of the goods by the second trader, upon recognizing the order receiving status or the production progress status of the second trader based on the communication with the second terminal device.

According to the commercial transaction management system of the present invention, in a case where the production cost of the goods by the second trader is changed in accordance with the order receiving status or the production progress status of the second trader, the first index depending on the cost needed for the commercial transaction for the second trader is corrected. Then, the second trader is selected based on the selection index, with the corrected first index reflected in the selection index. As a result, the second trader as the partner of commercial transaction with the first trader can be selected appropriately, in consideration of the individual and specific status of each second trader, such as the order receiving status and the production progress status of each of the second trader.

Further, the commercial transaction management system according to the present invention is characterized by further comprising a second correction processing unit for correcting the second index based on an order receiving status or a production progress status of the goods by the second trader, upon recognizing the order receiving status or the production progress status of the second trader based on the communication with the second terminal device.

According to the commercial transaction management system of the present invention, in a case where the production plan of the goods by the second trader is changed in accordance with the order receiving status or the production progress status of the second trader, the second index depending on the time needed for the commercial transaction for the second trader is corrected. Then, the second trader is selected based on the selection index, with the corrected second index reflected in the selection index. As a result, the second trader as the partner of commercial transaction with the first trader can be selected appropriately, in consideration of the individual and specific status of each second trader, such as the order receiving status and the production progress status of each of the second trader.

Still further, the commercial transaction management system according to the present invention is characterized by further comprising a third correction processing unit for correcting the third index based on ratings of quality of goods or level of service for each of the second trader by each of the first trader, upon recognizing the ratings of each of the second trader by each of the first trader based on the communication with the first terminal unit.

According to the commercial transaction management system of the present invention, when the quality of the goods or the level of the service is improved due to the effort of the second trader, the third index is corrected depending on the individual rating of the relevant second trader by the first trader. Then, the second trader is selected based on the selecting index, with the corrected third index reflected in the selection index. As a result, the second trader as the partner of the commercial transaction with the first trader can be selected appropriately, in consideration of the individual rating of the second trader by each first trader.

### BRIEF DESCRIPTION OF THE DRAWINGS

FIG. 1 is an explanatory view of a configuration of a commercial transaction management system as one embodiment of the present invention;

FIG. 2 is an explanatory view of a function of a commercial transaction management system as one embodiment of the present invention; and

FIG. 3 is an explanatory view of a function of a commercial transaction management system as one embodiment of the present invention.

### BEST MODE FOR CARRYING OUT THE INVENTION

An embodiment of the commercial transaction management system of the present invention will now be described with reference to the drawings.

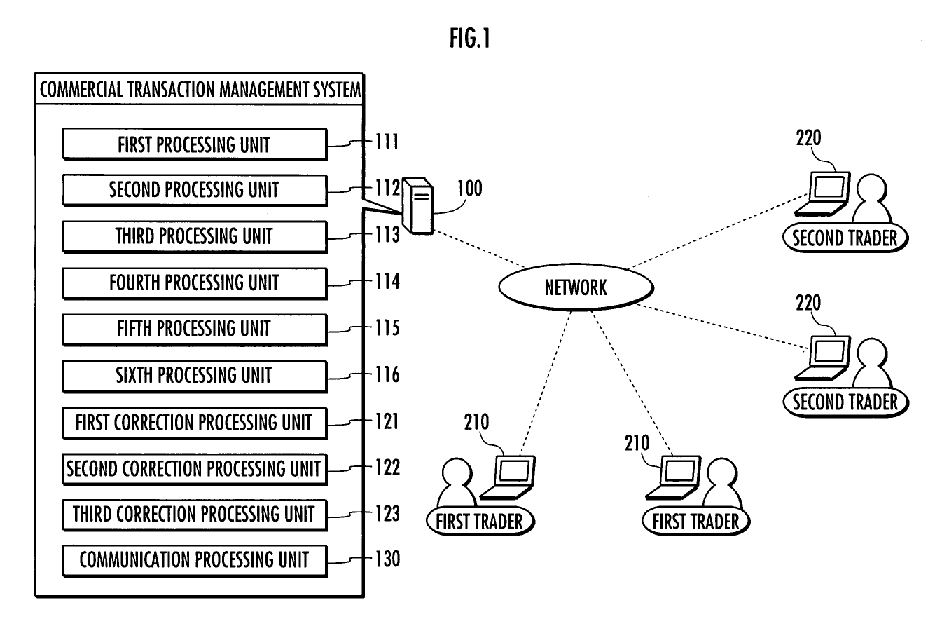

First, the structure of the commercial transaction management system will be explained with reference to FIG. 1.

The commercial transaction management system shown in FIG. 1 comprises a plurality of first terminal devices 210, a plurality of second terminal devices 220, and a commercial transaction management server (hereinafter referred to as “server”) 100 capable of communicating via network.

The server 100 is equipped with a first processing unit 111, a second processing unit 112, a third processing unit 113, a fourth processing unit 114, a fifth processing unit 115, a sixth processing unit 116, a first correction processing unit 121, a second correction processing unit 122, a third correction processing unit 123, and a communication processing unit 130. Each unit comprises a CPU, a ROM, a RAM, an electric circuit, and the like.

The first processing unit 111 recognizes a “placed order content” of each first trader, based on the communication with the first terminal device 210. The “placed order content” includes “category”, “quantity”, “desired delivery date”, and “priority rank” of the goods ordered by the first trader. Also, the first processing unit 111 determines a “first index” depending on “cost” needed for the commercial transaction for each second trader, based on a part of or all of the “placed order content” of each first trader.

The second processing unit 112 recognizes the “placed order content” of each first trader, based on the communication with the first terminal device 210, and then recognizes a “second index” depending on “time” needed for the commercial transaction for each second trader, based on a part of or all of the “placed order content”.

The third processing unit 113 recognizes “quality” of the goods or “level” of the service for each second trader, based on the communication with the first terminal device 210, and then determines a “third index” of each second trader depending on the “quality” or the “level”. The “level” of the service is identified by a delivery date compliance rate (=(quantity of goods delivered in compliance with the delivery date)/(quantity of total delivery)), or the contents of the contract in relation to the commercial transaction with the second trader.

The fourth processing unit 114 recognizes an “order placing policy” of the first trader, which indicates the importance for the first trader of the cost needed for the commercial transaction, the time needed for the commercial transaction, and the quality of the goods or the level of the service, based on the communication with the first terminal device 210. Also, the fourth processing unit 114 recognizes an “order receiving policy” of the second trader, which indicates the magnitude of the desire by the second trader to commence the commercial transaction with each of the first trader, based on the communication with the second terminal device 220. Further, the fourth processing unit 114 weighs the first, second, and third indexes based on the “order placing policy” of the first trader, and then determines a “selection index” for selecting the second trader based on the weighed first, second, and third indexes, and the “order receiving policy” of the second trader. Finally, the fourth processing unit 114 selects the second trader that receives the order for the goods from the first trader, based on the “selection index”.

The fifth processing unit 115 determines the “received order content” including the category, quantity, delivery date, and priority rank of the ordered goods received by the second trader, based on the “placed order content” of the first trader which is recognized by the first processing unit 111 or the second processing unit 112.

The sixth processing unit 116 recognizes a “production plan” of the goods output by the second terminal device 220, based on the communication with the second terminal device 220. Also, the sixth processing unit 116 recognizes a “delivery date” of the ordered goods produced by the second trader to the first trader, depending on the production plan.

The first correction processing unit 121 recognizes an “order receiving status” and “production progress status” of the goods by the second trader, based on the communication with the second terminal device 220, and then corrects the first index depending on the “order receiving status” and the “production progress status”.

The second correction processing unit 122 recognizes the “order receiving status” and the “production progress status” of the goods by the second trader, based on the communication with the second terminal device 220, and then corrects the second index depending on the “order receiving status” and the “production progress status”.

The third correction processing unit 123 recognizes a “rating” by the first trader concerning the quality of the goods or the level of the service for each second trader, based on the communication with the first terminal device 210. Also, the third correction processing unit 123 corrects the third index depending on the “rating” by the first trader for each second trader.

The communication processing unit 130 transmits the “received order content” determined by the fifth processing unit 115, to the second terminal device 220 of the second trader selected by the fourth processing unit 114. Also, the communication processing unit 130 transmits the delivery date recognized by the sixth processing unit 116 to the first terminal device 210.

The first terminal device 210 holds the information processing function, such as managing the “placed order content” and “order placing policy” of the first trader, the “rating” concerning the quality of the goods of the second trader and the like, and transmitting the same.

The second terminal device 220 holds the information processing function, such as managing and transmitting the “order receiving status”, “production progress status”, “order receiving policy” and the like of the second trader, and to output the “production plan” of the ordered goods depending on the “received order content” transmitted from the server 100.

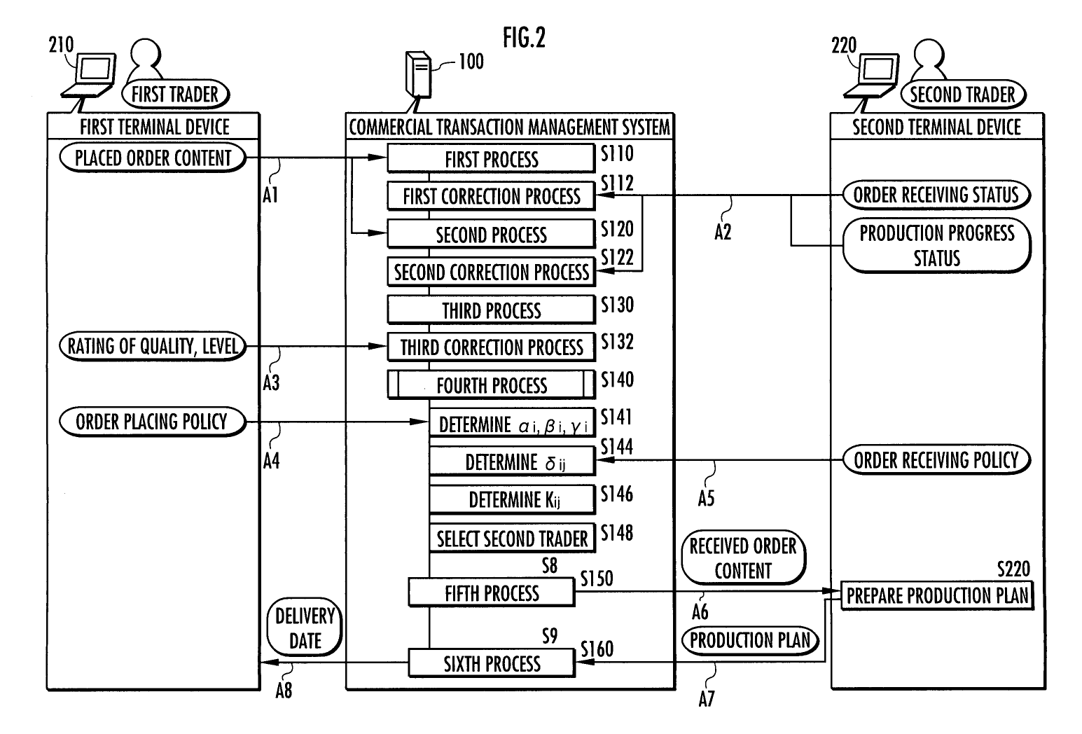

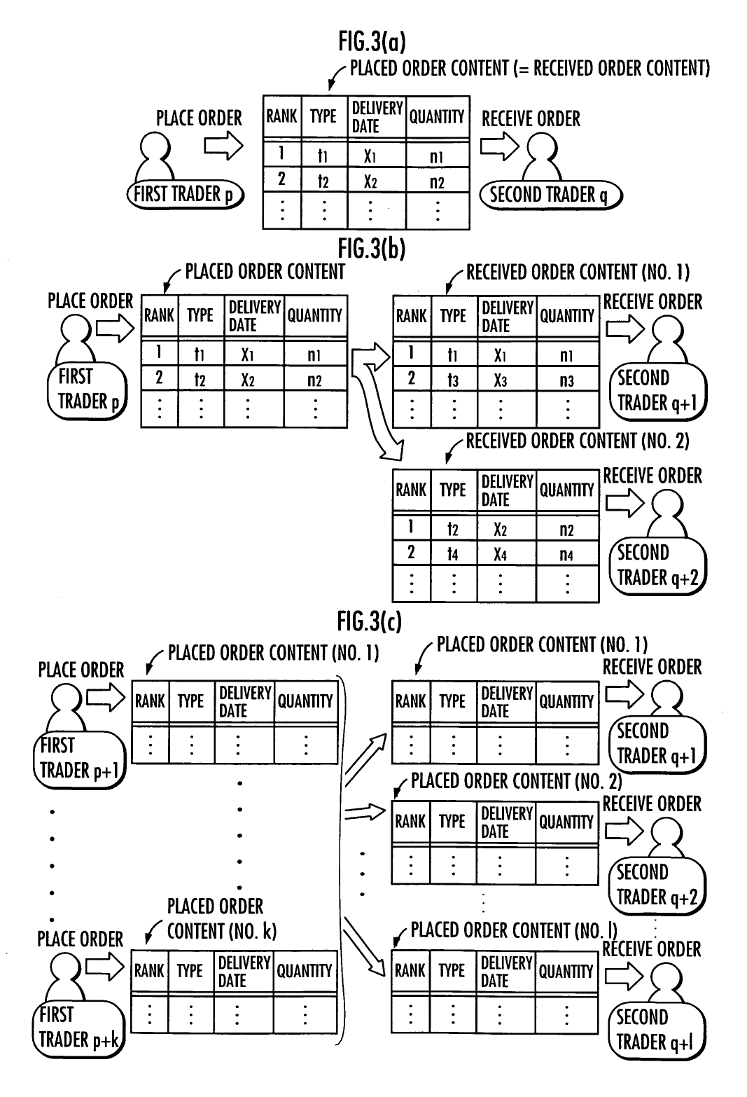

Next, the function of the commercial transaction management system having the structure mentioned above will be described with reference to FIGS. 2 and 3.

In FIG. 2, only one each of the first terminal device 210 and the second terminal device 220 is shown, just for the sake of simplifying the explanation, but in practice, a plurality of first terminal devices 210 and second terminal devices 220 exist, with a plurality of first traders placing order for the goods and a plurality of second traders receiving the order of the goods.

First, the first processing unit 111 performs a “first processing” (step S110 in FIG. 2). Specifically, each of the first terminal device 210 transmits the “placed order content” of each of the first trader to the server 100 (arrow A1 in FIG. 2), and the first processing unit 111 recognizes the “placed order content” of each of the first trader. As is shown in FIG. 3(a), the “placed order content” includes the “category”, the “quantity”, the “desired delivery date” and the “priority rank” of the ordered goods, such as “please deliver the following: the first priority goods of type t₁ by the due date (delivery date) x₁ in the quantity of n₁, the second priority goods of type t₂ by the due date x₂ in the quantity of n₂, . . . ”.

Next, the first processing unit 120 determines the first index aᵢⱼ for each of the second trader j (j≠i, j=1, 2, . . . ), based on a part of or all of the “placed order content” of the first trader i (i=1, 2, . . . ). The first index aᵢⱼ depends on the “cost” occurring when the first trader i and the second trader j conduct the commercial transaction, and is defined to decrease as the cost increases. The “cost” includes the cost of goods, employment cost, logistics cost, customs cost, tax, and the like.

Next, the first correction processing unit 121 performs the “first correction processing” (step S112 in FIG. 2). Specifically, each of the second terminal device 220 transmits the “order receiving status” and the “production progress status” of the goods of each of the second trader, to the server 100 (arrow A2 in FIG. 2), and the first correction processing unit 121 recognizes the “order receiving status” and the “production progress status” of each second trader. Then, the first correction processing unit 121 corrects the first index aᵢⱼ based on the “order receiving status” and the “production progress status” of the second trader j.

Next, the second processing unit 112 performs the “second processing” (step S120 in FIG. 2). Specifically, the second processing unit 112 recognizes the “placed order content” of each first trader transmitted from each of the first terminal device 210 to the server 100 (refer to arrow A1 in FIG. 2). Then, the second processing unit 112 determines the second index bᵢⱼ for each of the second trader j, based on a part of or all of the “placed order content” of the first trader i. The second index bᵢⱼ depends on the “time” needed for commercial transaction between the first trader i and the second trader j, and is defined to decrease as the time increases. The “time” needed for commercial transaction includes time needed for the production of the goods, the time needed for the delivery of the goods, and the like.

Next, the second correction processing unit 122 performs the “second correction process” (step S122 in FIG. 2). Specifically, the second correction processing unit 122 recognizes the “order receiving status” and the “production progress status” for each of the second trader, which is transmitted from each of the second terminal device 220 to the server 100 (refer to arrow A2 in FIG. 2). Then, the second correction processing unit 122 corrects the second index bᵢⱼ based on the “order receiving status” and the “production progress status” of the second trader j.

Next, the third processing unit 113 performs the “third process” (step S130 in FIG. 2). Specifically, the third processing unit 113 recognizes the “quality” of the goods or the “level” of the service, which is transmitted from a memory device (not shown) of the server 100 or a memory device of an external terminal device. Then, the third processing unit 113 determines the “third index cⱼ” for each of the second trader j according to the “quality” or the “level”. The third index cⱼ depends on the “quality” of the goods or the “level” of the service of the second trader j, and is defined to increase as the quality and the like improves. The “quality” is identified by the goodwill (. . . made in (by) . . . has superior quality, and the like) embodied by the second trader. The “level” includes the delivery date compliance rate (=(quantity of goods delivered in compliance with the delivery date)/(quantity of total goods delivered)), the contents of the contract in relation to the commercial transaction with the second trader, convenience of the payment of consideration to the second trader depending on the type of the currency, completeness of the after-sales service, and the like. The level or the like of the second trader recognized by the third processing unit 113 is an average value of the rating made by a plurality of first traders having actual commercial transaction with the second trader.

Next, the third correction processing unit 123 performs the “third correction process” (step S123 in FIG. 2). Specifically, the first terminal device 210 transmits the “rating” concerning the quality of the goods and the level of the service of the second trader j by the first trader I to the server 100 (arrow A3 in FIG. 2), and the third correction processing unit 123 recognizes the “rating”. Then, the third correction processing unit 123 corrects the third index cᵢ based on the “rating” made by the first trader i. The rating concerning the level and the like of the second trader j that is recognized by the third correction processing unit 123 is an individual rating evaluated by each of the first trader i having actual commercial transaction with the second trader j.

Next, the fourth processing unit 114 performs the “fourth process” (step S114 in FIG. 2). Specifically, the first terminal device 210 transmits the “order placing policy” of the first trader indicating the importance to the first trader of the cost needed for the commercial transaction, the time needed for the commercial transaction, and the quality of the goods or the level of the service to the server 100 (arrow A4 in FIG. 2), and the fourth processing unit 114 recognizes the “order placing policy” of the first trader i. Then, the fourth processing unit 114 determines the first coefficient aᵢ, the second coefficient βᵢ, and the third coefficient γᵢ, which are all positive numbers, for the first trader i depending on the “order placing policy” of the first trader i (step S142 in FIG. 2).

For example, if the order placing policy of the first trader i is to value the quality of the goods and the like more than the commercial transaction cost and the commercial transaction time (delivery date), then the third coefficient γᵢ is determined to be greater than the first coefficient aᵢ depending on the commercial transaction cost and the second coefficient βᵢ depending on the commercial transaction time. Also, if the order placing policy of the first trader i is to value the commercial transaction cost more than the quality of the goods and the like, and to value the commercial transaction time more than the commercial transaction cost, then the second coefficient βᵢ depending on the commercial transaction time is determined to be greater than the first coefficient aᵢ depending on the commercial transaction cost, and the first coefficient aᵢ depending on the commercial transaction cost is determined to be greater than the third coefficient γᵢ depending on the quality of the goods and the like. Further, if the order placing policy of the first trader i is to value each of the commercial transaction cost, the commercial transaction time (delivery date), and the quality of the goods and the like equally, then the first coefficient aᵢ, the second coefficient βᵢ, and the third coefficient γᵢ are determined to a predetermined magnitude relation (aᵢ=βᵢ=γᵢ, aᵢ>βᵢ=γᵢ, γᵢ>aᵢ>βᵢ, and the like).

Next, the second terminal device 210 transmits the “order receiving policy” of the second trader indicating the magnitude of the desire by the second trader to commence commercial transaction with each of the first trader to the server 100 (arrow A5 in FIG. 2), and the fourth processing unit 114 recognizes the “order receiving policy” of the second trader. Then, the fourth processing unit 114 determines the fourth coefficient dᵢⱼ, which is a positive number, for each of the first trader i based on the “order receiving policy” of the second trader j (step S144 in FIG. 2).

For example, if the “order receiving policy” of the second trader j is to prioritize the commercial transaction with the first trader b than the commercial transaction with the first trader a, then the fourth coefficient dₐⱼ of the first trader a and the second trader j is determined to be smaller than the fourth coefficient d_{bj} of the first trader b and the second trader j.

Next, the fourth processing unit 114 determines the selection index Kᵢⱼ with the formula (1), based on the first index aᵢⱼ, the second index bᵢⱼ, and the third index cⱼ, the first coefficient aᵢ, the second coefficient βᵢ and the third coefficient γᵢ, and the fourth coefficient dᵢⱼ (step S146 in FIG. 2). The selection index Kᵢⱼ is for selecting the second trader to be the partner of the commercial transaction with the first trader i, from a plurality of second traders j.
Kᵢⱼ=dᵢⱼ·{aᵢ·aᵢⱼ+βᵢ·bᵢⱼ+γᵢ·cⱼ} (1)

Then, the fourth processing unit 114 preferentially selects the second trader j (j=1, 2, . . . ) receiving the order of goods from the first trader i in the descending order of the selection index Kᵢⱼ (step S148 in FIG. 2).

For example, when the selection index K_{pq} (i=p, j=q) is the largest, then the second trader q is selected as the commercial transaction partner (=order receiving trader) of the first trader p (refer to FIG. 3(a)). Also, when the selection index K_{pq+1} (i=p, j=q+1) is the largest and the second index K_{pq+2} (i=p, j=q+2) is the second largest, then a plurality of second traders q+1 and q+2 may be selected as the second trader to receive the order of goods from the first trader p (refer to FIG. 3(b)). Further, a plurality of second traders q+1, q+2, . . . , q+1 may be selected as the second traders to receive order of goods from a plurality of first traders p+1, . . . , p+k in the descending order of the selection index Kᵢⱼ (refer to FIG. 3(c)).

Next, the fifth processing unit 115 performs the “fifth process” (step S150 in FIG. 2). Specifically, the fifth processing unit 115 determines the “received order content” of the second trader selected by the fourth processing unit 114, including the category, quantity, delivery date and the priority rank of the ordered goods (step S150 in FIG. 2), based on the “placed order content” of the first trader recognized by the first processing unit 111 or the second processing unit 112 (refer to arrow A1 in FIG. 2).

For example, when one second trader q is selected as shown in FIG. 3(a), the “placed order content (=deliver the first priority goods of type t₁ by the due date x₁ in the quantity of n₁, the second priority goods of type t₂ by the due date x₂ in the quantity of n₂, . . . ”) of the first trader is directly determined as the “received order content”.

Also, when a plurality of second traders q+1, q+2 is selected as shown in FIG. 3(b), a plurality of “received order content No. 1 (=deliver the first priority goods of type t₁ by the due date x₁ in the quantity of n₁, the second priority goods of type t₃ by the due date x₃ in the quantity of n₃, . . . )” and “received order content No. 2 (=deliver the first priority goods of type t₂ by the due date x₂ in the quantity of n₂, the second priority goods of type t₄ by the due date x₄ in the quantity of n₄, . . . )” may be determined by dividing the placed order content of the first trader.

Also, when a plurality of second traders q+1, q+2, . . . , q+1 is selected as the second trader for receiving order of goods from a plurality of first traders p+1, . . . , p+k, as shown in FIG. 3(c), a plurality of received order contents may be determined by integrating a plurality of placed order contents and then dividing the same.

Next, the communication processing unit 130 transmits the “received order content” determined by the fifth processing unit 114 to the second terminal device 220 of the second trader selected by the fourth processing unit 114 (arrow A6 in FIG. 2). Further, the second terminal device 220 prepares the production plan of the ordered goods depending on the received order content (step S220 in FIG. 2).

As a result, it is possible for the second trader to produce the goods according to the category, quantity, delivery date, and the priority rank of the ordered goods included in the “placed order content”, and to transport the goods according to the order to the first trader at an appropriate timing.

Next, the sixth processing unit 116 performs the “sixth process” (step S160 in FIG. 2). Specifically, the second terminal 220 transmits the “production plan” prepared by the second terminal 220 to the server 100 (arrow A7 in FIG. 2), and the sixth processing unit 116 recognizes the production plan. Then, the sixth processing unit 116 estimates the “delivery date” of the goods from the second trader to the first trader, based on the “production plan”.

Next, the communication processing unit 130 transmits the “delivery date” of the goods estimated by the sixth processing unit 116 to the first terminal device 210 of the first trader (arrow A8 in FIG. 2). As a result, it is possible for the first trader to prepare for the operation after receiving the ordered goods produced by the second trader, such as transporting the goods to the customers or the dealers, based on the delivery date.

According to the commercial transaction management system exerting the function mentioned above, the “cost” needed for the commercial transaction of the first trader i and the second trader j is reflected in the selection index Kᵢⱼ in the form of the first index aᵢⱼ (refer to step S110 in FIG. 2, equation (1)). Also, the “time” needed for the commercial transaction of the first trader i and the second trader j is reflected in the selection index Kᵢⱼ in the form of the second index bᵢⱼ (refer to step S120 in FIG. 2). Further, the “average rating” by a plurality of first traders concerning the quality of the goods or the level of the service of the second trader j is reflected in the selection index Kᵢⱼ in the form of the third index bⱼ (refer to step S130 in FIG. 2).

Also, the “order placing policy” of the first trader i is reflected in the selection index Kᵢⱼ in the form of the first coefficient aᵢ, the second coefficient βᵢ, and the third coefficient γᵢ (refer to step S142 in FIG. 2). Moreover, the “order receiving policy” of the second trader j to each of the first trader i is reflected in the selection index Kᵢⱼ in the form of the fourth coefficient dᵢⱼ (refer to step S144 in FIG. 2).

As a result, the second trader j to be the partner in the commercial transaction with each of the first trader i is selected based on the “selection index”, so that an appropriate second trader may be selected as the partner in the commercial transaction with the first trader i, from the viewpoint of the cost needed for the commercial transaction, the time needed for the commercial transaction, and the quality of the goods, and the “order placing policy” of the first trader and the “order receiving policy” of the second trader. By doing so, a smooth commercial transaction is made possible while eliminating conflict or friction between the traders, when a plurality of first traders i makes a plurality of order of goods, and a plurality of second traders j receives the order of goods.

Moreover, in a case where the production cost of the goods by the second trader is changed in accordance with the order receiving status or the production progress status of the second trader, the first index aᵢⱼ depending on the cost needed for the commercial transaction for the second trader is corrected (refer to step S112 in FIG. 2). Similarly, when the production plan of the goods by the second trader is changed in accordance with the order receiving status or the production progress status of the second trader, the second index bᵢⱼ depending on the time needed for the commercial transaction for the second trader is corrected (refer to step S122 in FIG. 2). Thereafter, the second trader is selected based on the selection index Kᵢⱼ, with the corrected first index aᵢⱼ and the second index bᵢⱼ reflected in the selection index Kᵢⱼ. By doing so, the second trader as the partner of commercial transaction with the first trader may be appropriately selected in consideration of the individual and specific status of each second trader, such as the order receiving status and the production progress status of each of the second trader.

Further, when the quality of the goods or the level of the service is improved due to the effort of the second trader, the third index is corrected depending on the individual rating of the second trader by the first trader (step S132 in FIG. 2). Thereafter, the second trader is selected based on the selection index Kᵢⱼ, with the corrected third index cⱼ reflected in the selection index Kᵢⱼ. By doing so, the second trader as the partner of commercial transaction with the first trader may be appropriately selected in consideration of the individual rating of the second trader by each of the first trader. For example, when a first trader gives high individual rating to a second trader whose average rating by a plurality of first traders is low, then this second trader is preferentially selected as the partner of commercial transaction with this first trader.

In the present embodiment, the selection coefficient Kᵢⱼ is determined according to the equation (1) mentioned above. However, as another embodiment, the selection coefficient Kᵢⱼ may be determined according to any equation, as long as the first index aᵢⱼ, the second index bᵢⱼ, and the third index cⱼ are reflected in the selection coefficient Kᵢⱼ with a weight (intensity) according to the “order placing policy” of the first trader i. Also, the selection coefficient Kᵢⱼ may be determined according to any equation, as long as the weight (intensity) towards each first trader according to the “order receiving policy” of the second trader j is reflected in the selection coefficient Kᵢⱼ.

Further, at least any one of the first correction process (refer to step S112 in FIG. 2), the second correction process (refer to step S122 in FIG. 2), and the third correction process (refer to step S132 in FIG. 2) may be omitted. Still further, the determination of the fourth coefficient dᵢⱼ according to the order receiving policy of the second trader (refer to step S144 in FIG. 2) may be omitted.

Also, the fourth processing unit 114 may select one second trader only as the partner of commercial transaction with the first trader when the selection coefficient Kᵢⱼ of this one second trader is a predetermined threshold or more (refer to FIG. 3(a)), and may select one second trader and another second trader as the partner of commercial transaction with the first trader when the selection coefficient Kᵢⱼ of this one second trader is less than the predetermined threshold (refer to FIG. 3(b)).

According to the present embodiment, in a case where the order received by one second trader cannot sufficiently satisfy the order of the first trader, commercial transaction satisfying the first trader may be encouraged by increasing the number of second traders receiving order of ordered goods from the first trader. Also, in the present embodiment, the threshold may be determined according to the “order placing policy” of the first trader.

1. A commercial transaction management system for managing commercial transaction between a plurality of first traders and a plurality of second traders as parties involved, based on network communication with a first terminal device of the first trader placing order of goods, and a second terminal device of the second trader receiving order of goods, comprising:
a first processing unit for determining a first index according to cost needed for commercial transaction with the first trader for each of the second trader, based on a part of or all of a placed order content of the first trader, upon recognizing the placed order content including category, quantity, desired delivery date, and priority rank of the ordered goods by the first trader based on the communication with the first terminal device;
a second processing unit for determining a second index according to time needed for commercial transaction with the first trader for each of the second trader, based on a part of or all of the placed order content of the first trader, upon recognizing the placed order content of the first trader based on the communication with the first terminal device;
a third processing unit for determining a third index according to quality or level, upon recognizing the quality of goods or the level of service of each of the second trader;
a fourth unit for determining a selection index for selecting the second trader, based on the first index, the second index, and the third index determined by the first processing unit, the second processing unit, and the third processing unit, respectively, and for determining the second trader receiving order of goods from the first trader, based on the selection index;
a fifth unit for determining a received order content including the category, quantity, delivery date, and priority rank of the ordered goods received by the second trader, based on the placed order content by the first trader recognized by the first or the second processing unit; and
a communication processing unit for transmitting the received order content determined by the fifth processing unit to the second terminal device of the second trader selected by the fourth processing unit.

2. The commercial transaction management system according to claim 1, wherein the fourth processing unit determines the selection index based on the first index, the second index, and the third index, upon recognizing an order placing policy of the first trader indicating the importance to the first trader of the cost needed for the commercial transaction, the time needed for the commercial transaction, and the quality of the goods or the level of the service, and upon weighing the first index, the second index, and the third index in accordance with the order placing policy of the first trader.

3. The commercial transaction management system according to claim 1, wherein the fourth processing unit determines the selection index based on an order receiving policy of the second trader indicating the magnitude of the desire by the second trader to have commercial transaction with each of the first trader, upon recognizing the order receiving policy of the second trader based on the communication with the second terminal device.

4. The commercial transaction management system according to claim 1, further comprising a sixth processing unit for recognizing a production plan of goods prepared by the second terminal device, based on the communication with the second terminal device to which the placed order content is transmitted by the communication processing unit, and for recognizing the delivery date to the first trader of the goods produced by the second trader in accordance with the production plan, wherein the communication processing unit transmits the delivery date recognized by the sixth processing unit to the first terminal device.

5. The commercial transaction management system according to claim 1, further comprising a first correction processing unit for correcting the first index based on an order receiving status or a production progress status of the goods by the second trader, upon recognizing the order receiving status or the production progress status of the second trader based on the communication with the second terminal device.

6. The commercial transaction management system according to claim 1, further comprising a second correction processing unit for correcting the second index based on an order receiving status or a production progress status of the goods by the second trader, upon recognizing the order receiving status or the production progress status of the second trader based on the communication with the second terminal device.

7. The commercial transaction management system according to claim 1, further comprising a third correction processing unit for correcting the third index based on ratings of quality of goods or level of service for each of the second trader by each of the first trader, upon recognizing the ratings of each of the second trader by each of the first trader based on the communication with the first terminal unit.
